(19) United States
(12) Patent Application Publication
(10) Pub. No.: US 2001/0004596 A1
(43) Pub. Date: Jun. 21, 2001

(54) Radio communication network and a method and control apparatus in the network

(76) Inventors: Jorgen Steijer, Frimurarvagen (SE); Sinead McAllister, Ennis (IE); Anthony Lee, Gold Stone Court (IE); Andreas Abrahamsson, Donnybrook Castle (IE)

Correspondence Address: Ronald L. Grudziecki, Burns, Doane, Swecker & Mathis, L.L.P., P.O. Box 1404, Alexandria, VA, 22313-1404, US

(21) Appl. No.: 09/736,320

(22) Filed: Dec. 15, 2000

(30) Foreign Application Priority Data
Dec. 16, 1999 (SE) 9904654-2

(51) Int. Cl. H04Q 7/20; H04B 1/38

(52) U.S. Cl. 455/436; 455/453; 455/561

(57) ABSTRACT

The present invention is related to managing resources in a radio communication network. The radio communication network comprises a first set of equipment and a second set of equipment. The first set of equipment is initially allocated (301) to serve a first call. Equipment reallocation (303) is initiated, whereby the second set of equipment is allocated to serve the first call and the first set of equipment is released from the first call, upon determining (302), according to a predetermined rule based on differences in functional capabilities of the first set of equipment and the second set of equipment, that it is desirable to serve the first call using the second set of equipment instead of the first set of equipment even though the first set of equipment is able to continue serving the first call.

### TECHNICAL FIELD OF THE INVENTION

The invention relates to a radio communication network and a method and control apparatus in the radio communication network. More specifically the invention relates to a method, control apparatus and radio communication network enabling reallocation of resources serving a call.

### DESCRIPTION OF RELATED ART

A typical cellular radio communication network, such as a cellular network conforming to e.g. the Personal Digital Cellular (PDC) or Global System for Mobile communication (GSM) standards, contains a mixture of old and new equipment. Typically the new generation of equipment supports an extended range of communication service configurations as compared to the old generation of the corresponding equipment type. As an example, an Ericssson CMS30 Mobile services Switching Centre (MSC) in a PDC cellular network may contain transcoders (TRAUs) of type TRAU-24, which is an older generation of transcoders, as well as transcoders of type TRAU-96, which is a newer generation of transcoders. A TRAU-24 transcoder is capable of handling both speech coding/decoding and rate adaptation of VSELP coded full rate speech calls and rate adaptation of non-speech calls. A TRAU-96 transcoder is capable of handling, in addition to VSELP coded full rate speech calls and non-speech calls, also PSI-CELP coded half rate speech calls and ACELP coded full rate speech calls. Another difference between the TRAU-96 and TRAU-24 transcoders is that the TRAU-24 transcoder can handle three simultaneous non-speech calls while the TRAU-96 can only handle a single non-speech call.

Each transcoder in the mobile services switching centre, together with a corresponding transceiver (TRX) in a base station is configured to handle a set of traffic channels. A transcoder/transceiver pair is allocated to serve a call by allocating a traffic channel in the set of traffic channels handled by said transcoder/transceiver pair to the call.

Since TRAU-96 transcoders support a wider range of communication service configurations, i.e. are more flexible, than TRAU-24 transcoders, the mobile services switching centre typically tries, when allocating a transcoder to serve a full rate VSELP speech or non-speech call in a cell, primarily to allocate a TRAU-24 transcoder to serve the call. Only when there is no TRAU-24 transcoder available, an available TRAU-96 transcoder will be allocated to serve said call. This way the risk is reduced that a situation arises in which there are available TRAU-24 transcoders but no available TRAU-96 transcoder which implies that, temporarily, the network is only able to serve additional calls which can be handled by a TRAU-24 transcoder, i.e. VSELP coded full rate speech calls and non-speech calls.

The transcoder/transceiver pair which have been allocated to serve a call remains allocated to the call until the call is disconnected or handover is performed. Handover is a procedure whereby a first traffic channel allocated to the call is replaced by a second traffic channel, i.e. the second traffic channel is allocated to the call and the first traffic channel is released from the call. In situations where the first and second traffic channel are not both handled by the same transcoder/transceiver pair, the handover procedure implies that the transcoder/transceiver pair handling the first traffic channel is released from the call while the transcoder/transceiver pair handling the second traffic channel is allocated to serve the call.

There are different reasons why the mobile services switching centre may decide to perform handover of a call.

The most common reason for performing a handover is that a mobile station involved in a call has moved from a geographical area in which radio coverage is provided by a first cell in the radio communication network to a geographical area in which radio coverage is provided by a second cell in the radio communication network and thus a traffic channel allocated to the call in the first cell needs to be replaced by a traffic channel in the second cell in order to maintain the call. The mobile services switching centre initiates handover for this reason when it detects that results of performed radio signal measurements relating to the call fulfill a handover criterion defined by a set of radio signal parameter threshold values.

Another reason to perform handover of a call between the two cells is that the traffic load of the first cell is very high while the traffic load of the second cell is significantly lower. A function called Cell Load Sharing in the mobile services switching centre enables calls involving mobile stations in the fringe of the first cell to be moved to the second cell. This provides the first cell with an increased capacity for handling calls in the centre of the first cell. The Cell Load Sharing function temporarily modifies radio signal parameter threshold values used to determine when to perform handover of calls from the first cell to the second cell. The mobile services switching centre then initiates handover of a call from the first cell to the second cell when it detects that results of performed radio signal measurements relating to the call fulfills the current handover criterion as defined by the temporarily modified radio signal parameter threshold values.

It is also possible to perform handover between traffic channels in the same cell, i.e. so called intra cell handover.

Intra cell handover may be performed for a call served by a traffic channel on a first radio frequency which is subject to significant interference in order to instead serve the call using a traffic channel on a radio frequency which is subject to less interference.

Intra cell handover may also be performed in connection with certain changes in the communication service configuration of a call. The following situations causes the mobile services switching centre to perform an intra cell handover in connection with communication service configuration changes.

When a current communication service configuration of an established call is half rate PSI-CELP coded speech and a party involved in the call requests a change in communication service configuration to full rate non-speech data, an intra cell handover is necessary to switch from the current half rate traffic channel used to a full rate channel.

When a TRAU-96 transcoder is allocated to serve at least a first call having a current communication service configuration of full rate non-speech and a second call having a current communication service configuration of full rate VSELP or ACELP speech and a party involved in the second call requests a change in communication service configuration to full rate non-speech data, an intra cell handover of the second call to another traffic channel on another transcoder is required, since the TRAU-96 transcoder can only handle a single non-speech call.

When, during setup of a call having an initial communication service configuration of full rate ACELP speech (implying that a TRAU-96 transcoder has been allocated to the call), it is determined that the call will involve two mobile stations and the radio communication network supports so called CODEC-THROUGH mode, i.e. conveying speech data transparently via the radio communication network without performing speech decoding/coding in the network, the mobile services switching centre initiates a change of communication service configuration to full rate VSELP speech. In order to notify the concerned mobile station of the changed communication service configuration, an intra cell handover is initiated.

In all three instances where intra cell handover is performed in connection with changes in the communication service configuration of a call, the intra cell handover is required in order to be able to change the communication service configuration of the call.

U.S. Pat. No. 5,883,897 teaches a method of providing synchronization during transcoder switching in a communication system. The communication system includes a base-station which is responsive to a mobile station via a communication resource. Information conveyed via the communication resource is transcoded by a first transcoder. The method of providing synchronization includes the steps of determining that a switch to a second transcoder is necessary and switching to the second transcoder. At this point, the second transcoder and the mobile station are synchronized such that the information conveyed to the mobile station is transcoded by the second transcoder via the communication resource. The step of determining is performed at a system controller which resides within the infrastructure equipment of the communication system. The step of determining is performed in response to either a request external to the infrastructure equipment or a request internal to the infrastructure equipment. The request external to the infrastructure equipment is based on requirements of the mobile station or a user within a public switched telephone network. The request internal to the infrastructure equipment is based on failure of the first transcoder, system capacity requirements or voice quality requirements. The switch to a second transcoder triggered by a request internal to the infrastructure equipment based on system capacity requirements is disclosed as involving forcing communications with mobile stations to implement different service options known to improve system capacity. The only disclosed example of how an increased system capacity may be achieved is by switching between an 8 kbps vocoder and a 13 kbps vocoder. A common characteristic of the different situations triggering a transcoder switch in U.S. Pat. No. 5,883,897, is that it is not possible to continue to use the first transcoder to serve the communication session, either due to a change of the communication service configuration to a configuration not supported by the first transcoder or due to failure of the first transcoder. Thus, in order to continue the communication session, it is strictly necessary to switch transcoder.

Review of the prior art cited above reveals no disclosure or suggestion of a method, control apparatus or radio communication network such as that described and claimed herein. It would be a distinct advantage to have a method, control apparatus and radio communication network which enable detection of situations where it is desirable, even though it is not strictly necessary, to serve a call using other equipment than the equipment currently allocated to the call and enable reallocation of resources accordingly. The present invention provides such a method, control apparatus and radio communication network.

### SUMMARY OF THE INVENTION

The problem dealt with by the present invention is to reduce the risk of dropped or unserved calls in a radio communication network.

The problem is solved essentially by a method of managing resources in the radio communication network which includes determining, based on differences in functional capabilities of the equipment currently allocated to serve the call and other equipment, that a first call is better served by an other equipment than the equipment currently allocated to serve the call and initiating equipment reallocation accordingly. The invention includes a control apparatus and a radio communication network implementing the method.

More specifically, the problem is solved in the following manner. The radio communication network comprises a first set of equipment and a second set of equipment. The first set of equipment is initially allocated to serve the first call. Equipment reallocation is initiated, whereby the second set of equipment is allocated to serve the first call and the first set of equipment is released from the first call, upon determining, according to a predetermined rule based on differences in functional capabilities of the first set of equipment and the second set of equipment, that it is desirable to serve the first call using the second set of equipment instead of the first set of equipment even though the first set of equipment is able to continue serving the first call.

In different embodiments of the invention, the differences in functional capabilities may include that the first set of equipment supports at least one communication service configuration, e.g. a certain speech coding algorithm, not supported by the second set of equipment or that the second set of equipment is capable of handling a larger number of simultaneous calls having a certain communication service configuration.

One object of the invention is to reduce the risk of dropped or unserved calls due to inefficient usage of resources in the cellular network.

Another object is to enable an increase of the available capacity in the radio communication network for handling additional calls requesting certain communication service configurations such as non-speech data.

One advantage afforded by the invention is that the risk of dropped or unserved calls due to inefficient usage of resources in the cellular network is reduced.

Another advantage is that the invention enables an increase of the available capacity in the radio communication network for handling additional calls requesting certain communication service configurations such as non-speech data.

The invention will now be described in more detail with reference to exemplary embodiments thereof and also with reference to the accompanying drawings.

### BRIEF DESCRIPTION OF THE DRAWINGS

FIG. 1 is a schematic view of a cellular network.

FIG. 2 is a schematic block diagram illustrating more details of nodes in the network of FIG. 1.

FIG. 3 is a flow chart illustrating a basic method according to the invention

FIG. 4 is a flow chart illustrating release of a channel on a TRAU-24 transcoder in connection with disconnection or handover of calls.

### DETAILED DESCRIPTION OF THE EMBODIMENTS

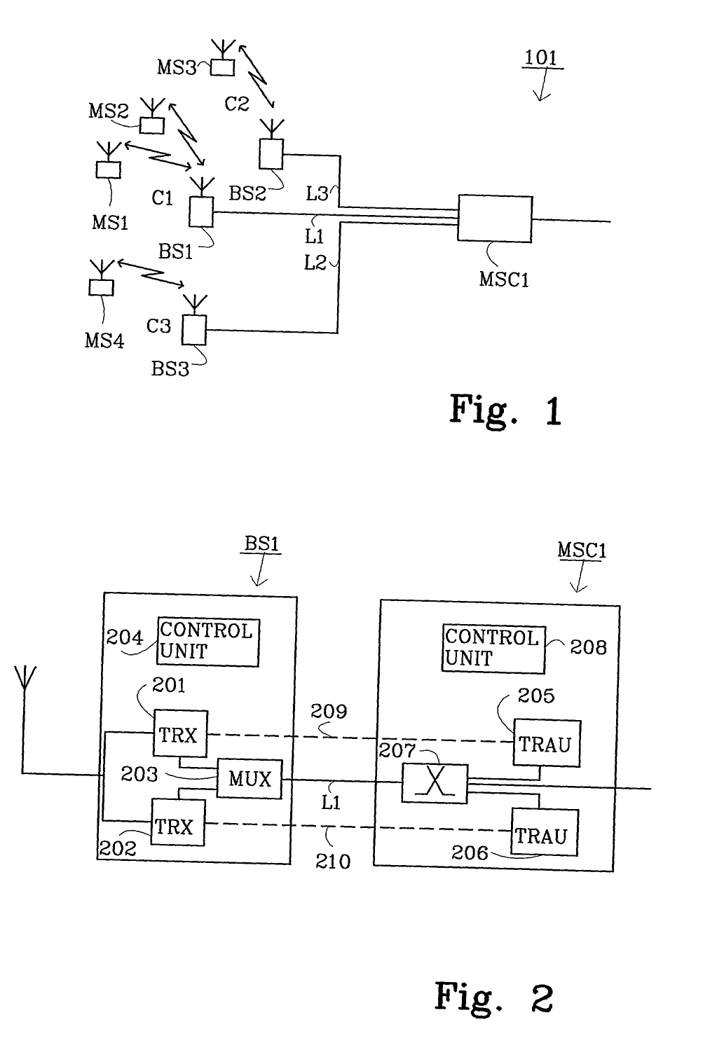

FIG. 1 illustrates a cellular network 101 providing a first exemplary embodiment of a radio communication network according to the present invention. The cellular network 101 comprises a mobile services switching center MSC1 and a set of base stations BS1-BS3 providing radio coverage in a geographical area served by the mobile services switching center MSC1. The geographical area served by the mobile services switching centre MSC1 is divided into a number of cells including cells C1-C3. In the cellular network 101 of FIG. 1 each base station BS1-BS3 is assumed to be serving a single cell, i.e. a first base station BS1 is serving a first cell C1, a second base station BS2 is serving a second cell C2, a third base station BS3 is serving a third cell C3. Mobile stations MS1-MS4 communicate with the cellular network 101 by transmitting radio signals to and receiving radio signals from the base stations BS1-BS3. The base stations BS1-BS3 and the mobile services switching centre MSC1 are interconnected via communication links L1-L3. The cellular network 101 and the mobile stations MS1-MS4 conform to the Personal Digital Cellular (PDC) specifications. The mobile services switching centre MSC1 and the base stations BS1-BS3 in this exemplary embodiment of a radio communication network according to the invention, are all derived from the Ericsson CMS30 for PDC product portfolio. Note that even though the radio communication network in this exemplary embodiment is based on the Ericsson CMS30 for PDC product portfolio, the invention may of course also be applied in radio communication networks including equipment from other Ericsson product portfolios or other vendors. Also note that only elements deemed necessary for illustrating the present invention are illustrated in FIG. 1 and thus a cellular radio communication network in which the invention is applied may comprise e.g. a greater number of base stations and mobile services switching centers as well as other types of nodes such as a home location register node.

FIG. 2 provides more details on the internal structure of the base station BS1 and the mobile services switching centre MSC1.

The base station BS1 comprises a set of transceivers (TRX) including a first transceiver 201 and a second transceiver 202, a multiplexor 203 and a control unit 204.

The mobile services switching centre MSC1 comprises a set of transcoding and rate adaptation units (TRAU), alternatively referred to as transcoders, including a first transcoder 205 and a second transcoder 206, a group switch 207 and a control unit 208. The control unit is responsible for overall control of the mobile services switching centre MSC1 and includes at least one processor and at least one memory unit storing software instructions executed by the at least one processor.

When configuring the transcoders 205-206 of the mobile services switching centre MSC1 and the transceivers 201-202 of the base station BS1, the first transcoder 205 together with the first transceiver 201 and the second transcoder 206 together with the second transceiver 202 are configured to form a first transcoder/transceiver pair 201, 205 and a second transcoder/transceiver pair 202, 206 respectively. Logical links in the form of semipermanent circuits 209-210 are established between the transcoder and transceiver in each transcoder/transceiver pair via the group switch 207, the communication link L1 and the multiplexor 203.

The first transcoder/transceiver pair 201, 205 is configured to handle a first set of traffic channels in the first cell C1 and the second transcoder/transceiver pair 202, 206 is configured to handle a second set of traffic channels in the first cell C1.

Depending on the type of transcoders and transceivers included in the first and second transcoder/transceiver pair respectively, the first and second transcoder/transceiver pairs may have different functional capabilities. In a first exemplary scenario, the first transcoder 205 is an Ericsson TRAU-96 transcoder and the second transcoder 206 is an Ericsson TRAU-24 transcoder while both the first transceiver 201 and the second transceiver 202 are Ericsson TRX-5 transceivers 201.

Since the Ericsson TRX-5 transceiver fully supports operation with both TRAU-24 and TRAU-96 transcoders, differences in functional capabilities of the first transcoder/transceiver pair 201, 205 and the second transcoder/transceiver pair 202, 206 are caused only by the differences in functional capabilities of the respective transcoder type.

A TRAU-24 transcoder, which belong to an older generation of transcoders, is capable of supporting calls having the following communication service configurations:

full rate VSELP (Vector Sum Excited Linear Predictive coding) coded speech (FR VSELP);

full rate non-speech (i.e. DATA/FAX).

A TRAU-96 transcoder, which belongs to a newer generation of transcoders, is capable of supporting calls having the following communication service configurations:

half rate PSI-CELP (Pitch Synchronous Innovation—Code Excited Linear Predictive coding) coded speech (HR PSI-CELP);

full rate ACELP (Algebraic Code Excited Linear Predictive coding) coded speech (FR ACELP i.e. EFR);

full rate VSELP coded speech (FR VSELP);

full rate non-speech.

Another difference between the TRAU-96 and TRAU-24 transcoder types is that the TRAU-24 transcoder can handle three simultaneous non-speech calls while the TPAU-96 can only handle a single non-speech call.

Thus since the first transcoder 205 is a TRAU-96 transcoder and the second transcoder 206 is a TRAU-24 transcoder, the functional capabilities of the first transcoder/transceiver pair 201, 205 and the second transcoder/transceiver pair 202, 206 differs in that the first transcoder/transceiver pair 201, 205 supports an extended range of communication service configurations, i.e. half rate PSI-CELP speech and full rate ACELP speech, as compared to the second transcoder/transceiver pair 202, 206 while the second transcoder/transceiver pair 202, 206 is capable of handling a larger number of simultaneous non-speech calls than the first transcoder/transceiver pair 201, 205.

Based on the differences in the functional capabilities of the first transcoder/transceiver pair 201, 205, the second transcoder/transceiver pair 202, 206, and other transcoder/transceiver pairs serving the first cell C1, the control unit 208 of the mobile services switching centre MSC1 allocates transcoder/transceiver pairs to serve calls in the first cell C1 according to a certain scheme determined in accordance to the network operators preferences on the proper balance between capacity for handling non-speech calls, providing enhanced speech quality by using ACELP coded speech and providing increased capacity for handling speech calls by using half rate PSI-CELP coded speech. A transcoder/transceiver pair is allocated to serve a call by allocating a traffic channel in a set of traffic channels said transcoder/transceiver pair is configured to handle, e.g. allocation of the first transcoder/transceiver pair 201, 205 to serve the call is performed implicitly by allocating a traffic channel in the first set of traffic channels to the call.

In a first exemplary scenario, a scheme is used which is based on the principle to try and allocate TRAU-24 transcoders to serve calls as far as possible and thus only allocate TRAU-96 transcoders to serve calls having communication service configurations which are supported by both TRAU-24 and TRAU-96 transcoders when there is no TRAU-24 transcoder available. TRAU-96 transcoders are of course also always allocated to serve calls having communication service configurations which are only supported by TRAU-96 transcoders. By allocating equipment according to this scheme, the risk is reduced that a situation arises in which the cellular network 101 temporarily is only able to serve new calls in the first cell C1 having a restricted range of communication service configurations, i.e. the range of communication service configurations which are supported by a TRAU-24 transcoder.

Allocation of traffic channels in the first cell C1 is performed in accordance with the above described scheme when establishing a new call or performing handover of a call. The handover may either be a handover of a call from another cell, e.g. the second cell C2 or the third cell C3, or an intra cell handover.

Even though the mobile services switching centre MSC1, when allocating a traffic channel to a call in the first cell Cl, allocates a traffic channel which, based on the communication service configuration of the call and the functional capabilities of the available transcoder/transceiver pairs, is the most suitable transcoder/transceiver pair available, moments later a more suitable transcoder/transceiver pair may have become available after being released from another call. As a consequence of the call not being served by the most suitable transcoder/transceiver pair, the resources of the cellular network 101 are not used in an efficient way. This may have the effect of causing the cellular network 101 to reject establishment of new calls or, as a consequence of not being able to perform required handovers, dropping calls which could have been served if the resources had been used more efficiently.

The invention deals with the problem of reducing the risk of dropped or unserved calls due to inefficient usage of resources in the cellular network.

The basic principle of the invention is to initiate equipment reallocation for a first call upon determining, according to a predetermined rule based on differences in functional capabilities of a first set of equipment currently serving the first call and an available second set of equipment, that it is desirable to serve the first call using the second set of equipment instead of the first set of equipment even though the first set of equipment is able to continue serving the first call. The equipment reallocation involves allocating the second set of equipment to serve the first call and releasing the first set of equipment from the first call. The first set of equipment and the second set of equipment may e.g. correspond to the first transcoder/transceiver pair 201, 205 and the second transcoder/transceiver pair 202, 206 respectively in FIG. 2.

One key characteristic of the invention, is that reallocation of equipment supporting the first call, is initiated even though the first set of equipment currently allocated to serve the first call is able to continue serving the first call, i.e. performing the reallocation of equipment is not strictly necessary to maintain the first call.

Another key characteristic of the invention, is that the rule used to determine that it is desirable to serve the first call using the second set of equipment instead of the first set of equipment, is based on differences in functional capabilities of the first set of equipment and the second set of equipment. Thus the equipment reallocation will be initiated if, due to said differences in functional capabilities between the first set of equipment and the second set of equipment, it is more appropriate to serve the first call using the second set of equipment instead of the first set of equipment currently allocated to serve the first call.

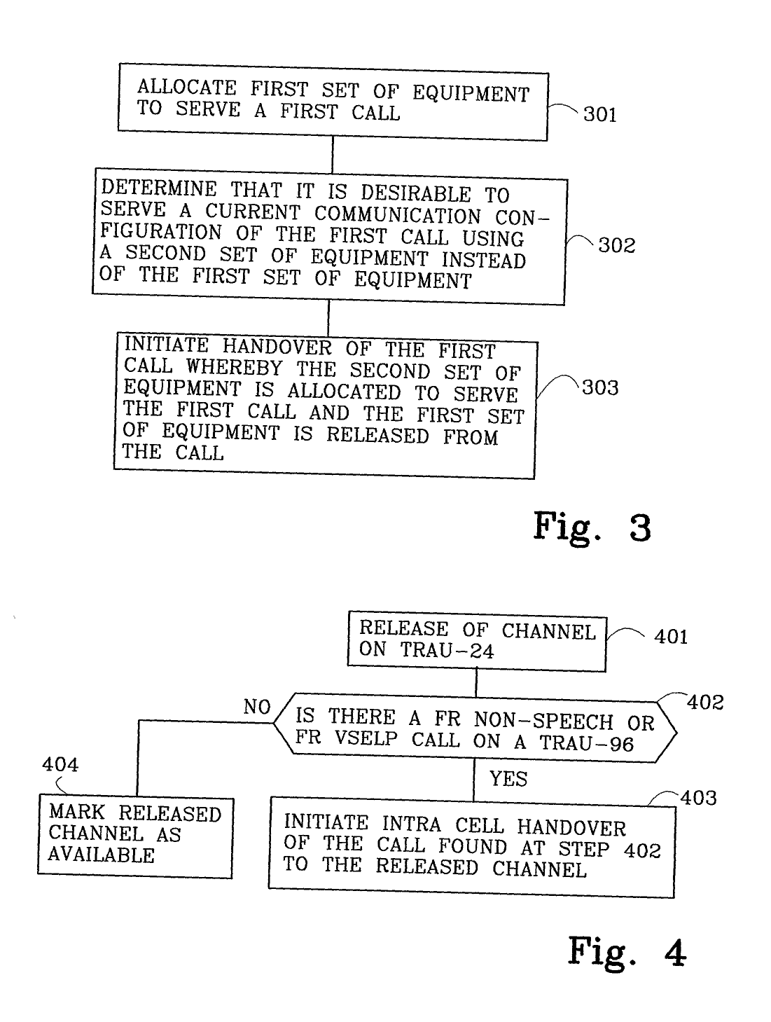

FIG. 3 illustrates a first exemplary embodiment of a method according to the invention for managing resources in the cellular network 101. The method is described using an example scenario in which the second transcoder/transceiver pair 202, 206 and all other transcoder/transceiver pairs including TRAU-24 transcoders handling traffic channels in the cell C1 are unavailable when a request for establishment of a first call in cell C1 is received by the cellular network 101.

At step 301 the first transcoder/transceiver pair 201, 205 is allocated to serve the first call. Traffic channel allocation is performed by the control unit 208 in the mobile services switching centre MSC1 according to the scheme previously described. In this particular example scenario, the requested communication service configuration of the first call is full rate non-speech. The control unit 208 tries to find an available TRAU-24 transcoder, but since none is available, a traffic channel in the first set of traffic channels handled by the first transcoder/transceiver pair 201, 205 is allocated.

After a while, the second transcoder/transceiver pair 202, 206 is released from a second call. This may occur e.g. as a result of the second call being disconnected or handed over from the first cell C1 to another cell, e.g. the second cell C2.

At step 302, the control unit 208 of the mobile services switching centre MSC1 determines that, even though the first transcoder/transceiver pair 201, 205 is capable of handling the current communication service configuration of the first call, i.e. full rate non-speech, it is desirable to serve the current communication service configuration of the first call using the second transcoder/transceiver pair 202, 206 instead of the first transcoder/transceiver pair 201, 205. The rule applied when determining that it is desirable to serve the first call using the second transcoder/transceiver pair 202, 206 instead of the first transcoder/transceiver pair 201, 205, is that calls currently served by a TRAU-96 transcoder and having a communication service configuration supported by a TRAU-24 transcoder, i.e. full rate VSELP coded speech or full rate non-speech, should be handled by a TRAU-24 transcoder instead whenever there is an available TRAU-24 transcoder.

In the present example scenario, step 302 is performed upon release of the second transcoder/transceiver pair 202, 206 from the second call.

At step 303, the control unit 208 initiates an intra cell handover of the first call, whereby the second transcoder/transceiver pair 202, 206 is allocated to serve the first call and the first transcoder/transceiver pair 201, 205 is released from the first call.

FIG. 4 illustrates actions performed by the control unit 208 in the mobile services switching centre MSC1 upon release of a traffic channel.

At step 401 a traffic channel handled by a TRAU-24 transcoder, e.g. the second transcoder 206, is released.

At step 402, the control unit 208 checks whether there is a full rate non-speech call or full rate VSELP call which is served by a TRAU-96 transcoder, e.g. the first transcoder 205.

If a full rate non-speech call or full rate VSELP call served by a TRAU-96 transcoder is found (an alternative YES at step 402), the control unit 208 proceeds by initiating an intra cell handover of the call found at step 402 from the traffic channel currently allocated to said call on a TRAU-96 transcoder, to the traffic channel released at step 401. If no full rate non-speech call or full rate VSELP call served by a TRAU-96 transcoder is found (an alternative NO at step 402), the control unit 208, at step 404, just marks the released channel as being available for allocation to other calls.

The control unit 208 of the mobile services switching centre MSC1 in the cellular network 101 implements the means necessary for implementing the first exemplary embodiment of a method according to the invention, i.e. method steps 301-303, and thus the mobile services switching centre MSC1 acts as a control apparatus for managing resources in accordance with the invention.

Apart from the exemplary first embodiment of the invention disclosed above, there are several ways of providing rearrangements, modifications and substitutions of the first embodiment resulting in additional embodiments of the invention.

In the exemplary first embodiment, the differences in terms of the functional capabilities of the first transcoder/transceiver pair 201, 205 and the second transceiver/transcoder pair 202, 206 are caused only by the differences in functional capabilities of the respective transcoder type, TRAU-96 and TRAU-24 respectively. It is however of course also possible that differences in functional capabilities of transceiver/transcoder pairs may arise due to differences in functional capabilities of the transceivers included in the respective transcoder/transceiver pair.

As an alternative to configuring fixed transcoder/transceiver pairs, transcoders can be organized into one or several transcoder pools, wherein each transcoder pool serves a number of cells. Logical links between transcoders and transceivers could then be dynamically created and released when needed.

In the exemplary first embodiment of the invention, the predetermined rule applied when determining that it is desirable to serve the first call using the second transcoder/transceiver pair 202, 206 instead of the first transcoder/transceiver pair 201, 205, is that calls currently served by a TRAU-96 transcoder and having a communication service configuration supported by a TRAU-24 transcoder should be handled by a TRAU-24 transcoder instead of by the TRAU-96 transcoder whenever there is an available TRAU-24 transcoder. Applying this rule ensures that, as far as possible, there are TRAU-96 transcoders available and thus the cellular network is able to serve new calls having communication service configurations only supported by TRAU-96 transcoders, i.e. full rate ACELP coded speech or half rate PSI-CELP coded speech. However, the network operator is of course free to specify other rules for determining, based on the differences in functional capabilities of different sets of equipment, when it is desirable to serve a call using other equipment than the equipment currently allocated to serve the call. As an example, an alternative rule could be that TRAU-24 transcoders should be reserved for handling full rate non-speech calls as far as possible and thus a full rate VSELP coded call currently served by a TRAU-24, should instead be served by a TRAU-96 transcoder whenever there is an available TRAU-96 transcoder. Applying this alternative rule increases the network capacity for handling full rate non-speech calls.

Yet another possible modification of the exemplary first embodiment of the invention, could be to perform the method steps 302 and 303 in FIG. 3 only when the load of the network, e.g. measured in terms of the processing load of the control unit 208 in the mobile services switching centre MSC1 or the number of ongoing calls in the first cell C1, exceeds a first threshold value but still is less than a higher second threshold value. This modification would result in the steps 302 and 303 not being performed when the cellular network is only handling a small amount of traffic, implying that there are plenty of available transceiver/transcoder pairs so there is no real need to optimize resource usage, or when the cellular network is very heavily loaded, implying that the mobile services switching centre MSC1 and the base stations BS1-BS3 may have no available capacity for performing resource usage optimization due to being too busy performing basic traffic handling functions.

In the exemplary first embodiment of the invention, equipment reallocation is performed by initiating an intra cell handover of the first call in the first cell. There are alternative ways of performing equipment reallocation in the context of the invention.

One alternative way of performing equipment reallocation would be to initiate a handover of a call in the first cell C1 to a neighbouring cell, e.g. the second cell C2. This alternative implies that the control unit 208 of the mobile services switching centre MSC1 is adapted to consider not only transcoder/transceiver pairs configured to serve calls in the first cell C1 as candidates for serving the call, but also transcoder/transceiver pairs configured to serve calls in the second cell C2. The control unit 208, when determining that it would be desirable to serve the call using a transcoder/transceiver pair configured to serve calls in the second cell C2 instead of the transcoder/transceiver pair currently serving the call in the first cell, would need to also consider, based on performed radio signal measurements relating to the call, whether the call could be maintained in the second cell C2.

Yet another alternative way of performing equipment reallocation would be to perform a transcoder switching for a call in accordance with the method disclosed in U.S. Pat. No. 5,883,897 instead of performing a handover.

In a first set of embodiments of the invention, including the exemplary first embodiment of the invention, the determining step triggering equipment reallocation involves determining, based on differences in functional capabilities of a first set of equipment, currently allocated to serve a first call, and an available second set of equipment, that it is desirable to serve a current communication service configuration of the first call using the second set of equipment instead of the first set of equipment even though the first set of equipment is capable of handling the current communication service configuration of the first call. Thus, in this set of embodiments of the invention, the same communication service configuration is used both before and after the equipment reallocation.

In the first set of embodiments, the determining step may be performed upon release of the second set of equipment from a second call as disclosed in FIG. 4, but may also be performed in connection with other events, such as upon receipt of a request for establishment of a third call which requires allocation of equipment supporting a communication service configuration not supported by the second set of equipment but which is supported by the first set of equipment. After release of the first set of equipment from the first call, the first set of equipment would then immediately be allocated to serve the third call.

As another alternative, available equipment supporting different communication service configurations could be monitored and said step of determining performed upon detecting that, for at least one communication service configuration not supported by the second set of equipment, but which is supported by the first set of equipment, there is no available equipment.

In a second set of embodiments of the invention, the determining step triggering equipment reallocation is performed upon changing communication service configuration of a first call to a new communication service configuration and involves determining, based on differences in functional capabilities of a first set of equipment, currently allocated to serve the first call, and an available second set of equipment, that it is desirable to serve the new communication service configuration of the first call using the second set of equipment instead of the first set of equipment even though the first set of equipment is capable of handling the new communication service configuration of the first call. The determining step may be performed upon changing communication service configuration of the first call from a communication service configuration not supported by the second equipment to a communication service configuration supported by the second set of equipment.

The present invention can be applied in connection with a wide range of different types of radio communication networks including D-AMPS, GSM, IS-95, UMTS and CDMA2000. Depending on the architecture of the radio communication network in which the invention is applied, different nodes of the radio communication network may act as a control apparatus according to the invention. As an example, in a GSM-network a node type called base station controller (BSC) is responsible for handling channel allocation and the base station controller (BSC) is consequently the most appropriate node in the GSM-network to act as a control apparatus according to the invention.

1. A method of managing resources in a radio communication network (101), the radio communication network comprising a first set of equipment (201, 205) and a second set of equipment (202, 206),
the method comprising the steps of:
allocating (301) the first set of equipment (201, 205) to serve a first call;
performing equipment reallocation (303), whereby the second set of equipment (202, 206) is allocated to serve the first call and the first set of equipment (201, 205)is released from the first call;
characterized in that the step of performing equipment reallocation is initiated upon determining (302), according to a predetermined rule based on differences in functional capabilities of the first set of equipment (201, 205) and the second set of equipment (202, 206), that it is desirable to serve the first call using the second set of equipment (202, 206) instead of the first set of equipment (201, 205) even though the first set of equipment (201, 205) is able to continue serving the first call.

2. A method according to claim 1, wherein at least one difference in functional capabilities of the first set of equipment (201, 205) and the second set of equipment (202, 206) is that the first set of equipment (201, 205) supports at least one communication service configuration not supported by the second set of equipment (202, 206).

3. A method according to any one of claims 1-2, wherein at least one difference in functional capabilities of the first set of equipment (201, 205) and the second set of equipment (202, 206) is that the second set of equipment (202, 206) is capable of handling a larger number of simultaneous calls having a certain communication service configuration.

4. A method according to any one of claims 1-3, wherein the step of performing equipment reallocation involves initiating a handover of the first call.

5. A method according to claim 4, wherein the handover of the first call is a handover from a first cell (C1) to a second cell (C2).

6. A method according to any one of claims 4, wherein the handover of the first call is an intra cell handover of the first call in a first cell (C1).

7. A method according to any one of claims 1-6, wherein the first set of equipment (201, 205) is configured to handle a first set of communication channels and the second set of equipment (202, 206) is configured to handle a second set of communication channels and wherein allocation of the first set of equipment (201, 205) to serve a call is performed by allocating a communication channel in the first set of communication channels to the call and release of the first set of equipment (201, 205) from a call is performed by releasing a communication channel in the first set of communication channels from the call while allocation of the second set of equipment (202, 206) to serve a call is performed by allocating a communication channel in the second set of communication channels to the call and release of the second set of equipment (202, 206) from a call is performed by releasing a communication channel in the second set of communication channels from the call.

8. A method according to any one of claims 1-7, wherein the first set of equipment (201, 205) includes a first type of transceiver (201) and the second set of equipment (202, 206) includes a second type of transceiver (202).

9. A method according to any one of claims 1-8, wherein the first set of equipment (201, 205) includes a first type of transcoder (205) and the second set of equipment (202, 206) includes a second type of transcoder (206).

10. A method according to any one of claims 1-9, wherein the step of determining is performed upon release of the second set of equipment (202, 206) from a second call.

11. A method according to any one of claims 2-9, wherein the step of determining is performed upon receiving a request for a third call which requires allocation of equipment supporting a communication service configuration not supported by the second set of equipment (202, 206) but which is supported by the first set of equipment (201, 205) and the method further comprises a step of allocating the first set of equipment (201, 205) to serve the third call after being released from the first call.

12. A method according to claim 2-9, wherein the method comprises a step of monitoring available equipment supporting different communication service configurations and wherein the step of determining is performed upon detecting that, for at least one communication service configuration included in the at least one communication service configuration not supported by the second set of equipment (202, 206), there is no available equipment.

13. A method according to any one of claims 1-12, wherein said determining involves determining that it is desirable to serve a current communication service configuration of the first call using the second set of equipment (202, 206) instead of the first set of equipment (201, 205) even though the first set of equipment (201, 205) is capable of handling the current communication service configuration of the first call.

14. A method according to any one of claims 1-9, wherein said determining is performed upon changing communication service configuration of the first call to a new communication service configuration and said determining involves determining that it is desirable to serve the new communication service configuration of the first call using the second set of equipment (202, 206) instead of the first set of equipment (201, 205) even though the first set of equipment (201, 205) is capable of handling the new communication service configuration of the first call.

15. A method according to claim 14, wherein said determining is performed upon changing communication service configuration of the first call from a communication service configuration not supported by the second set of equipment (202, 206) to a communication service configuration supported by the second set of equipment (202, 206).

16. A control apparatus (MSC1) for managing resources in a radio communication network (101), the radio communication network (101) comprising a first set of equipment (201, 205) and a second set of equipment (202, 206), the control apparatus comprising:
allocating means (208) for allocating the first set of equipment (201, 205) to serve a first call;
characterized in that the control apparatus further comprises:
determining means (208) for determining, according to a predetermined rule based on differences in functional capabilities of the first set of equipment (201, 205) and the second set of equipment (202, 206), that it is desirable to serve the first call using the second set of equipment (202, 206) instead of the first set of equipment (201, 205) currently allocated to serve the call even though the first set of equipment (201, 205) is able to continue serving the first call;
equipment reallocation means (208) for performing equipment reallocation, whereby the second set of equipment (202, 206) is allocated to serve the first call and the first set of equipment (201, 205) is released from the first call, upon said determining by the determining means (208).

17. A control apparatus (MSC1) according to claim 16, wherein at least one difference in functional capabilities of the first set of equipment (201, 205) and the second set of equipment (202, 206) is that the first set of equipment (201, 205) supports at least one communication service configuration not supported by the second set of equipment (202, 206).

18. A control apparatus (MSC1) according to any one of claims 16-17, wherein at least one difference in functional capabilities of the first set of equipment (201, 205) and the second set of equipment (202, 206) is that the second set of equipment (202, 206) is capable of handling a larger number of simultaneous calls having a certain communication service configuration.

19. A control apparatus (MSC1) according to any one of claims 16-18, wherein the equipment reallocation means (208) are adapted to perform said equipment reallocation by initiating a handover of the first call.

20. A control apparatus (MSC1) according to claim 19, wherein the handover of the first call is a handover from a first cell (C1) to a second cell (C2).

21. A control apparatus (MSC1) according to claim 19, wherein the handover of the first call is an intra cell handover of the first call in a first cell (C1).

22. A control apparatus (MSC1) according to any one of claims 16-21, wherein the first set of equipment (201, 205) includes a first type of transceiver (201) and the second set of equipment (202, 206) includes a second type of transceiver (202).

23. A control apparatus (MSC1) according to any one of claims 16-22, wherein the first set of equipment (201, 205) includes a first type of transcoder (205) and the second set of equipment (202, 206) includes a second type of transcoder (206).

24. A control apparatus (MSC1) according to any one of claims 16-23, wherein the determining means (208) are adapted to perform said determining upon release of the second set of equipment (202, 206) from a second call.

25. A control apparatus (MSC1) according to any one of claims 17-23, wherein the determining means (208) are adapted to perform said determining upon the radio communication network receiving a request for a third call which requires allocation of equipment supporting a communication service configuration not supported by the second set of equipment (202, 206) but which is supported by the first set of equipment (201, 205) and wherein the allocating means (208) are adapted to allocate the first set of equipment (201, 205) to serve the third call after it has been released from the first call.

26. A control apparatus (MSC1) according to any one of claims 17-23, wherein the determining means (208) are adapted to monitor available equipment supporting different communication service configurations and wherein said determining is performed upon detecting that, for at least one communication service configuration included in the at least one communication service configuration not supported by the second set of equipment (202, 206), there is no available equipment.

27. A control apparatus (MSC1) according to any one of claims 16-26, wherein said determining involves determining that it is desirable to serve a current communication service configuration of the first call using the second set of equipment (202, 206) instead of the first set of equipment (201, 205) even though the first set of equipment (201, 205) is capable of handling the current communication service configuration of the first call.

28. A control apparatus (MSC1) according to any one of claims 16-23, wherein the determining means (208) are adapted to perform said determining upon change of communication service configuration of the first call to a new communication service configuration and said determining involves determining that it is desirable to serve the new communication service configuration of the first call using the second set of equipment (202, 206) instead of the first set of equipment (201, 205) even though the first set of equipment (201, 205) is capable of handling the new communication service configuration of the first call.

29. A control apparatus (MSC1) according to claim 28, wherein the determining means (208) are adapted to perform said determining upon change of communication service configuration of the first call from a communication service configuration not supported by the second set of equipment (202, 206) to a communication service configuration supported by the second set of equipment (202, 206).

30. A radio communication network (101) comprising a control apparatus according to any one of claims 16-29.
